(19) United States
(12) Patent Application Publication
(10) Pub. No.: US 2006/0092650 A1
(43) Pub. Date: May 4, 2006

(54) Dazzle dice

(76) Inventor: Gilbert G. Firneisz, Eugene, OR (US)

Correspondence Address: JAMES RAY & ASSOCIATES, 2640 Pitcairn Road, Monroeville, PA, 15146, US

(21) Appl. No.: 11/215,383

(22) Filed: Aug. 30, 2005

Related U.S. Application Data
(60) Provisional application No. 60/623,799, filed on Oct. 29, 2004.

(51) Int. Cl. B60Q 3/00

(52) U.S. Cl. 362/488; 362/545

(57) ABSTRACT

An apparatus disposed in an automobile for providing decoration and entertainment for users and other viewers. The apparatus comprises a pair of cube like members having a predetermined number of dots disposed on each surface thereof simulating a pair of dice. There is a means for illuminating each dot disposed within each of the pair of cube like members. A wiring means is engageable with the means for illuminating the dots for providing power to the means for illuminating each dot, and a power source connected to the wiring means for proving power to the means for illuminating each dot disposed within each of the pair of cube like members.

### CROSS REFERENCE TO RELATED APPLICATIONS

This application is closely related to and claims benefit from U.S. Provisional Application Ser. No. 60/623,799 filed Oct. 29, 2004.

### FIELD OF THE INVENTION

The present invention relates, in general, to decorative dice which hang from a rear view mirror in an automobile, and more particularly, the present invention relates to a pair of dice which light up with flashing LED lights to simulate rolling dice.

### BACKGROUND OF THE INVENTION

There have been a wide variety of decorative items that automobile drivers hang from the rear view mirrors of the automobile. One of he most widely used items has been a pair of fuzzy dice like members. These items just hang from the rear view mirror without any action on the part of the item. It would be interesting if these items could perform some action to enliven their usage.

### SUMMARY OF THE INVENTION

Thus, the present invention provides an apparatus disposed in an automobile for providing decoration and entertainment for users and other viewers. The apparatus comprises a pair of cube like members having a predetermined number of dots disposed on each surface thereof simulating a pair of dice. There is a means for illuminating each dot disposed within each of the pair of cube like members. A wiring means is engageable with the means for illuminating the dots for providing power to the means for illuminating each dot disposed within each of the cube like members, and a power source connected to the wiring means for proving power to the means for illuminating each dot disposed within each of the pair of cube like members.

### OBJECTS OF THE INVENTION

It is one of the objects of the invention to provide a pair of dice hanging from a rear view mirror with LED lights.

Another object of the invention is to provide a pair of dice hanging from a rear view mirror with randomly flashing lights.

Yet another object of the invention is to provide a pair of dice hanging from a rear view mirror with lights which represent the rolling of such dice.

Still another object of the invention is to provide a pair of dice hanging from a rear view mirror with lights which are controlled by a random number generator.

Additionally it is an object of the invention to provide a pair of dice hanging from a rear view mirror with lights which are powered by battery operated power pack mounted on the back of the rear view mirror.

It is another object of the invention to provide a pair of dice hanging from a rear view mirror with lights which are powered by a control module that plugs into a lighter socket.

In addition to the various objects and advantages of the invention which have been described in some specific detail above it should be noted that various other objects and advantages of the present invention will become more readily apparent to those persons who are skilled in the relevant art from the following more detailed description, particularly, when such description is taken in conjunction with the attached drawing Figures and with the appended claims.

### BRIEF DESCRIPTION OF THE DRAWINGS

FIG. 1 is a partial perspective front view of a pair of cube like members hanging from a rear view mirror according to an embodiment of the invention.

FIG. 2 is a partial perspective view of an alternate embodiment of the invention showing a control module for connection to an external source.

FIG. 3 is a partial perspective view of the apparatus with the control module connected to a cigarette lighter of an automobile as the external source according to an alternate embodiment of the invention.

FIG. 4 is a partial perspective view of the apparatus connected to a battery pack mounted on the rear view mirror of an automobile according to the embodiment of the invention shown in FIG. 1.

### BRIEF DESCRIPTION OF THE PRESENTLY PREFERRED AND VARIOUS ALTERNATIVE EMBODIMENTS OF THE INVENTION

Prior to proceeding to the more detailed description of the invention, it should be noted that identical components having identical functions have been designated with identical reference numerals throughout the several views illustrated in the drawings for the sake of clarity.

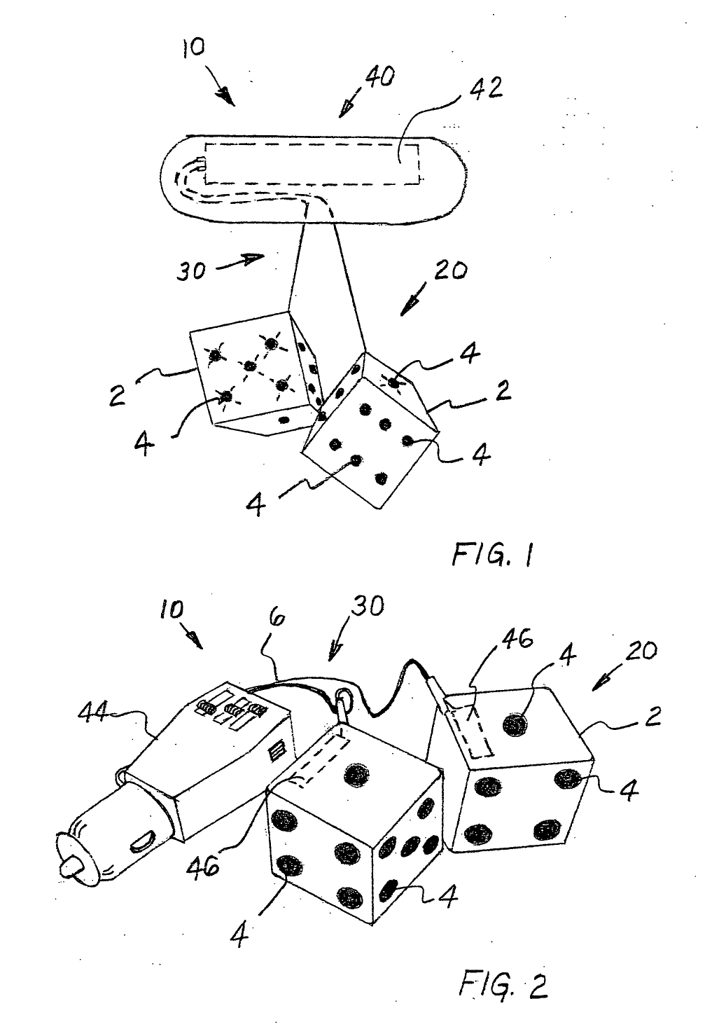

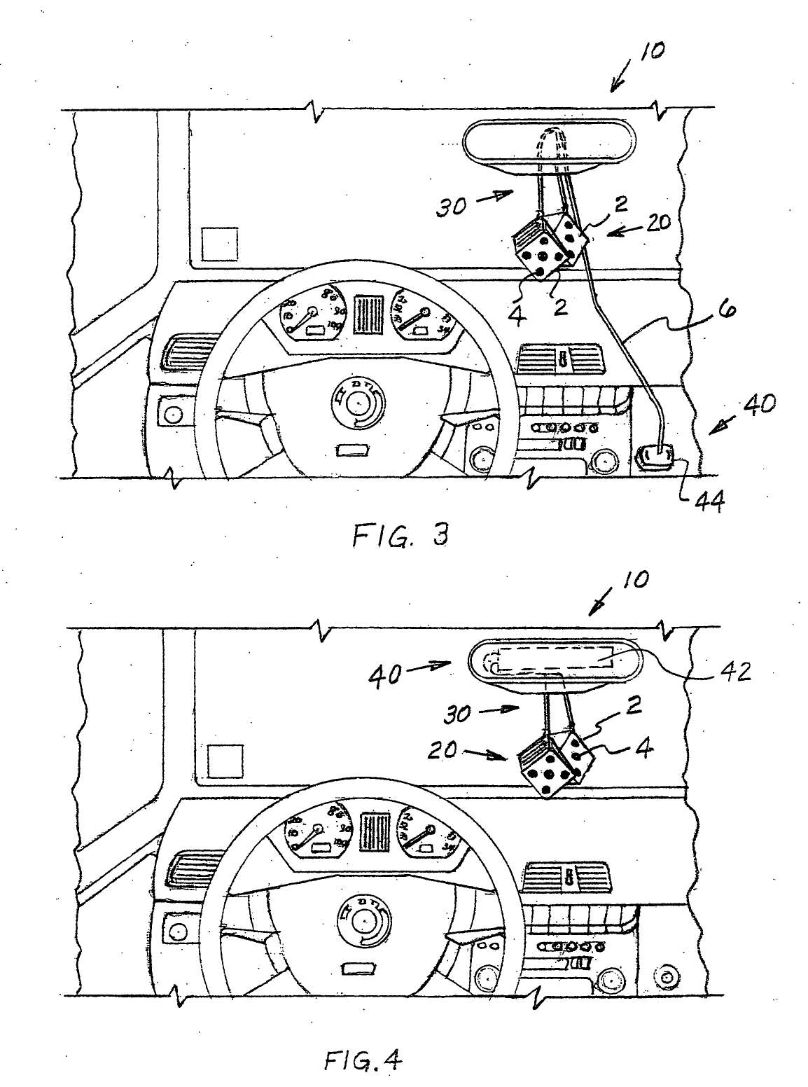

Illustrated in FIGS. 1-4, the present invention provides an apparatus, generally designated 10, disposed in an automobile for providing decoration and entertainment for users and other viewers. The apparatus 10 comprises a pair of cube like members 2 having a predetermined number of dots 4 disposed on each surface thereof simulating a pair of dice.

There is a means for illuminating each dot, generally designated 20, disposed within each of the pair of cube like members 2. A wiring means, generally designated 30, is engageable with the means for illuminating 20 the dots for providing power to the means for illuminating 20 each dot disposed within each of the cube like members 2, and a power source, generally designated 40, connected to the wiring means 30 for providing power to the means for illuminating each dot 20 disposed within each of the pair of cube like members 2.

It is presently preferred that such power source 40 be selected from one of a battery pack 42 and a control module 44 which connects to an external source. It is presently preferred that such external source to which the control module 44 is connected to is a cigarette lighter of an automobile, truck, recreational vehicle or boat. Also it is preferred that such battery pack 42 be disposed on a rear view mirror and more preferably on the back of the mirror. It is also preferred that such battery pack 42 include at least one of an on/off switch and an automatic sleep mode for preventing battery damage. As stated previously such cube like members 2 are designed to hang from a rear view mirror in such automobile as such dice have been used in the past.

The means for illuminating each dot 20 that is disposed within each of the pair of cube like members are flashing LED lights. Such flashing LED lights are controlled by a random number generator 46 or a PIC micro controller 46. It is presently preferred that such flashing LED lights are controlled by a random number generator 46.

As designed, the object of the invention is to enhance the effect of ordinary fuzzy dice (cubes) 2 hanging from the mirror so as to simulate rolling of the dice by the twenty one randomly flashing protruding LED lights representing each dot 4 of each digit on each cube 2 (die) surface. Each die 2 will flash a digit (comprised of individual LED's), independently, randomly and simultaneously with each other.

The random number generator 46 or PIC micro controller will be the element that ultimately selects the number to be displayed. The rate of the flashing digits is adjustable in frequency for a predetermined time duration. As the predetermined time approaches its value, the frequency rate of the flashing digits will slow down to an eventual and complete stop. The random digits generated (one per cube 2) and hence displayed, will remain until the event is triggered again.

The triggering can be via a time duration switch, or a motion switch. An automatic sleep mode will prevent battery drainage from taking effect after a period of non-activity.

It is within the concept of the invention that such dice 2 can be set to randomly flash continually instead of stopping on random numbers. Alternatively, the LED lights could be made to flash to music instead of using the random generator as described above.

As mentioned previously the power source 40 can be supplied via the battery 42 or the external source control module 44 which in the preferred embodiment plugs into the cigarette lighter on the car. If such apparatus 10 is powered externally then such items like switches, potentiometers and other control hardware could be enclosed within the external source control module 44. Power is supplied to the cubes 2 via a multi-conductor cable 6 long enough to route around the windshield to the mirror location. Electronics such as random number generator 46, LED drivers etc. can be located within the cubes 2.

As discussed the random number generator 46 determines an order in which the flashing LED lights are lit and the flashing LED lights simulate rolling of dice.

It is within the scope of the invention that such means for illuminating 20 the LED lights on each dot 4 is disposed within each of pair of cube like members 2 and includes providing each LED light with a predetermined color. Thus, the light can be white, another predetermined color or multi-colored. Such predetermined color includes blue, red, white, yellow, green and violet.

The color for each LED light on each dot can be the same or the color for each LED light on each dot could be different thereby creating a rainbow of color effect.

The cubes 2 can be constructed of opaque plastic with a white furry coating which will allow the light to glow through the covering.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for use in at least one of an automobile, recreational vehicle, truck and a boat for providing decoration and entertainment for users and other viewers, said apparatus comprising:
(a) a pair of cube like members having a predetermined number of dots disposed on each surface thereof simulating a pair of dice;
(b) a means for illuminating each dot disposed within each of said pair of cube like members;
(c) a wiring means engageable with said means for illuminating said dots for providing power to said means for illuminating each dot disposed within each of said cube like members; and
(d) a power source connected to said wiring means for providing power to said means for illuminating each dot disposed within each of said pair of cube like members.

2. The apparatus, according to claim 1, wherein said power source is selected from a battery pack and a control module connected to an external source.

3. The apparatus, according to claim 2, wherein said external source to which said control module is connected is a cigarette lighter in said at least one of such automobile, recreational vehicle, truck and a boat.

4. The apparatus, according to claim 2, wherein said battery pack is disposed on a rear view mirror.

5. The apparatus, according to claim 4, wherein said battery pack includes an on/off switch.

6. The apparatus, according to claim 1, wherein said apparatus is designed to hang from a rear view mirror in such automobile.

7. The apparatus, according to claim 6, wherein said apparatus is suspended from such rear view mirror by use of said wiring means.

8. The apparatus, according to claim 1, wherein said means for illuminating each dot disposed within each of said pair of cube like members are flashing LED lights.

9. The apparatus, according to claim 8, wherein said flashing LED lights are controlled by a random number generator.

10. The apparatus, according to claim 9, wherein said random number generator determines an order in which said flashing LED lights are lit.

11. The apparatus, according to claim 8, wherein said flashing LED lights simulate rolling of dice.

12. The apparatus, according to claim 8, wherein said means for illuminating said LED lights on each dot disposed within each of said pair of cube like members includes providing each LED light with a predetermined color.

13. The apparatus, according to claim 12, wherein said predetermined color is selected from a group consisting of blue, red, white, yellow, green and violet.

14. The apparatus, according to claim 12, wherein said predetermined color for each LED light on each dot is the same.

15. The apparatus, according to claim 12, wherein said predetermined color for each LED light on each dot is different.

16. The apparatus, according to claim 9, wherein said random number generator is disposed within at least one of said pair of cube like members.

17. The apparatus, according to claim 1, wherein said apparatus is disposed in a location behind a front seat of a vehicle for viewing by passengers.

18. The apparatus, according to claim 4, wherein said battery pack includes an automatic sleep mode to prevent battery damage.
